(19) United States
(12) Patent Application Publication
(10) Pub. No.: US 2003/0079939 A1
(43) Pub. Date: May 1, 2003

(54) Easy and safe descending device

(76) Inventor: Xiaoling Wang, Princeton Junction, NJ (US)

Correspondence Address: Mr. Walter J. Tencza Jr., Suite 3, 10 Station Place, Metuchen, NJ, 08840, US

(21) Appl. No.: 10/001,548

(22) Filed: Oct. 31, 2001

(51) Int. Cl. A62B 1/16

(52) U.S. Cl. 182/5; 182/193

(57) ABSTRACT

The present invention provides a method and an apparatus help people quickly and safely descend from a high-rise building in a severe emergency situation when regular evacuation routes are no longer available. An apparatus is disclosed including a base device, a cover device, and a handle device. The base device can be connected to a rope so that the base device can slide up and down the rope. The cover device can be connected to the base device. The handle device can adjust a position of the cover device with respect to the base device in order to provide an adjustable frictional force to the rope. This adjustable frictional force allows the combination of the base device, cover device and handle device to slide up or down the rope at different speeds.

### FIELD OF THE INVENTION

This invention relates to devices that allow a person in an emergency situation to safely descend to ground from a high building or an elevated place.

### BACKGROUND OF THE INVENTION

High-rise buildings offer great working and living spaces in big cities. Although they are in general well equipped with reasonable emergency exits and evacuation paths, they are clearly not sufficiently equipped and not designed to handle severe terrorist attacks, such as the World Trade Center attacks which happened on Sep. 11, 2001. Some people were forced to jump out of windows to avoid death by fire and smoke. Many people didn't have enough time to exit the buildings quickly. Many people didn't exit the buildings because the escape routes were blocked by fire and smoke or damaged.

There have been many attempts to provide safe descending devices for escaping from buildings and for mountain climbing activities. Since most devices designed for mountain or rock climbing activities are designed for a small group of people with some training, they are in general too difficult to use for the general public which may vary greatly in terms of weight, shape, size, and physical and psychological strength. In addition, the devices created for rock or mountain climbing activities are designed for descending one person at a time and for descending a relatively short distance of say less than one hundred meters. Therefore these devices are clearly not very suitable descending devices for escaping from high-rise buildings that are very often higher than one hundred meters and more than one person may need to descend from one rope during a given time interval.

Although there have been many inventions related to rope descending devices, most of them fail to satisfy one or more important criteria.

Some rope based descending devices, as described in U.S. Pat. No. 4,311,218 to Steffen, U.S. Pat. No. 4,385,679 to Mulcahy, and U.S. Pat. No. 5,597,052 to Rogleja, did not provide a gripping handle for two hands so that a normal person without special training would feel unsafe and uneasy to use them. These patents are incorporated by reference herein. In addition, letting a rope slide through a user's hands may also cause burns easily. Some other rope descending devices, such as disclosed in U.S. Pat. No. 4,662,475 to Ruetschi et al, U.S. Pat. No. 4,883,146 to Varner et al, U.S. Pat. No. 5,058,706 to Pai, and U.S. Pat. No. 5,234,075 to Lowden, require that an open end of a rope be inserted through the descending devices. In most high-rise building emergency cases, a rope for descending may have already been installed so that a plurality of people descend from the building using the same rope within a short period of time. In this particular case, it is extremely important that a rope based descending device can easily be hooked up and later released from the existing rope. This requires that the rope based descending device must be able to “attach” to the rope without inserting an open end of the rope through the device. Therefore, any rope descending devices that need to insert an open end of a rope to hook-up and release are not suitable as emergency descending devices to be used by people in high-rise buildings. Some other rope descending devices, as described in U.S. Pat. No. 4,223,761 to Sonnberger and U.S. Pat. No. 6,079,518 to Cho are relatively complicated to produce so that they may not be the best choice as a preferred descending device for millions of people working or living in high-rise buildings. Another rope descending device as described in U.S. Pat. No. 5,145,036 to Omalia may stop completely when a user releases the handle of the device. Although this safety feature is a welcome one for some mountain and rock climbing applications, it could leave a plurality of people descending from the same rope hanging in the air if one of them has released the handle. This is certainly not a welcome situation when many people need to descend quickly from a high-rise building.

### SUMMARY OF THE INVENTION

The present invention is designed to help those people who do not have enough time to escape or escape routes are blocked, to quickly and safely descend from a high-rise building in a severe emergency situation when other regular evacuation possibilities are no longer available.

The present invention in one or more embodiments provides a safe descending device or apparatus for escaping from high-rise buildings. The apparatus may include a base device, a cover device and a handle device. In one embodiment the handle device can be used to change a position of the cover device with respect to the base device and thereby alter an adjustable friction force. The safe descending device in one or more embodiments can include one or all of the following features:

1. Easy to use,

2. Secure and safe,

3. Fast and easy “hook-up” and “release” from a rope,

4. Not stoppable in the middle of a descending process,

5. Weight-customizable,

6. Fine descending speed control.

7. Handle for gripping with two hands for feeling safe and secure and avoiding hand burn,

8. Relatively compact and light-weighted, and

9. Economical and solid design with only a few parts

The present invention in one or more embodiments provides a cost-effective, easy-to-use, and safe solution that enables people to quickly escape by using a rope from a high-rise building in a severe emergency situation.

It is an object of the invention that the disclosed device or apparatus is easy to use so that people without special training can use it effectively.

It is another object of the invention that the disclosed device is secure and safe so that people can have sufficient confidence to use it in an emergency situation.

It is yet another object of the invention that the disclosed device is fast and easy to “hook-up” and “release” from a rope so that more people can descend down a rope quickly. This is essential when hundreds people need to be evacuated from a high-rise building in a severe emergency situation.

It is yet another object of the invention that the disclosed device is not stoppable in the middle of a descending process, at least in some embodiments, so that one panicked person will not cause other people who are attempting to descend down the rope to hang in the air on the rope. This is very important for allowing many people to quickly descend from a high-rise building.

It is yet another object of the invention that the disclosed device is weight-customizable. Since this device is intended to be used by millions of people who are working in high-rise buildings, it must work for a wide range of different weights.

It is yet another object of the invention that the disclosed device is equipped with a fine descending speed control. Although the weight-customization capability can roughly compensate the different weights for reaching roughly the same descending speed, it still can happen that one person may descend too fast or too slow. In this case, a fine descending speed control is essential and useful.

It is yet another object of the invention that the disclosed device or apparatus provides a handle for gripping with two hands. This is important to avoid any hand burns when a person is descending from a high-rise building, which could be caused for example if a rope were fed through the hands of a user. The handle is also useful for letting people feel safe and secure when using the device or apparatus.

It is yet another object of the invention that the disclosed device is relatively compact and light-weight so that it can be stored anywhere and can be moved quickly from place to place.

It is yet another objective of the invention that the disclosed device has an economical and solid design with only several parts. Since the device is intended to be used by millions of people who work and live in high-rise buildings, it should be cost-effective to produce.

### BRIEF DESCRIPTION OF THE DRAWINGS

FIG. 1A shows a perspective view of an apparatus including a base device, a cover device, and a handle device, connected to a rope in accordance with one embodiment of the present invention;

FIG. 1B shows a top view of the apparatus and the rope of FIG. 1A;

FIG. 2 is a perspective view of the apparatus of FIG. 1A taken apart;

FIG. 3 is a perspective view of the base device and the rope of FIG. 1A connected together;

FIG. 4 is a perspective view of the base device, the rope, and the cover device of FIG. 1A connected together, with the base device of FIG. 1A connected at one end to one end of the cover device of FIG. 1A;

FIG. 5 is a perspective view of another apparatus, in accordance with another embodiment of the present invention, shown taken apart;

FIG. 6 is a perspective view of a another apparatus, in accordance with another embodiment of the present invention, shown taken apart;

FIG. 7 shows the perspective view of FIG. 4 and a plate for insertion into the cover device of FIG. 4;

FIGS. 8A, 8B, and 8C show perspective views of another base device and another plate in accordance with another embodiment of the present invention;

FIGS. 9A and 9B show perspective views of two handle devices for use in one or more of the embodiments of the present invention;

FIG. 10 shows a typical safety harness with four hooks which can be used with one or more embodiments of the present invention; and

FIGS. 11A, 11B, and 11C show perspective views of the safety harness of FIG. 10 connected to the apparatus of FIG. 1A; the apparatus of FIG. 5, and the apparatus of FIG. 6, respectively.

### DETAILED DESCRIPTION OF THE INVENTION

The present invention discloses a speed-controllable device or apparatus that allows people in an emergency situation to safely descend to ground from a high-rise building or an elevated place.

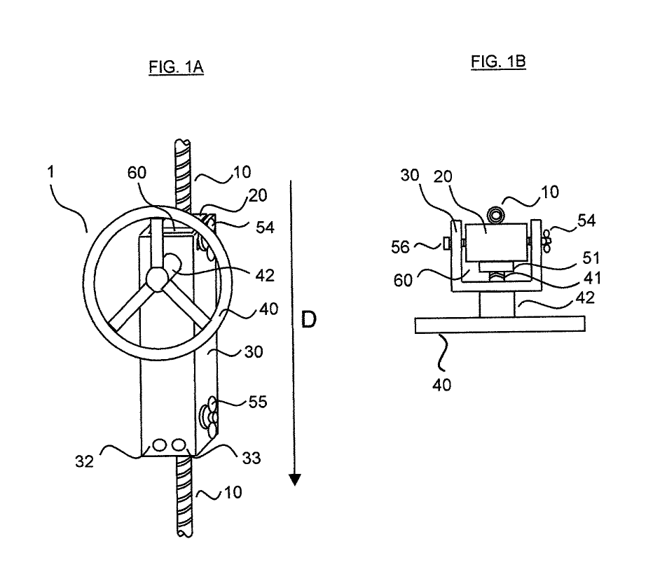

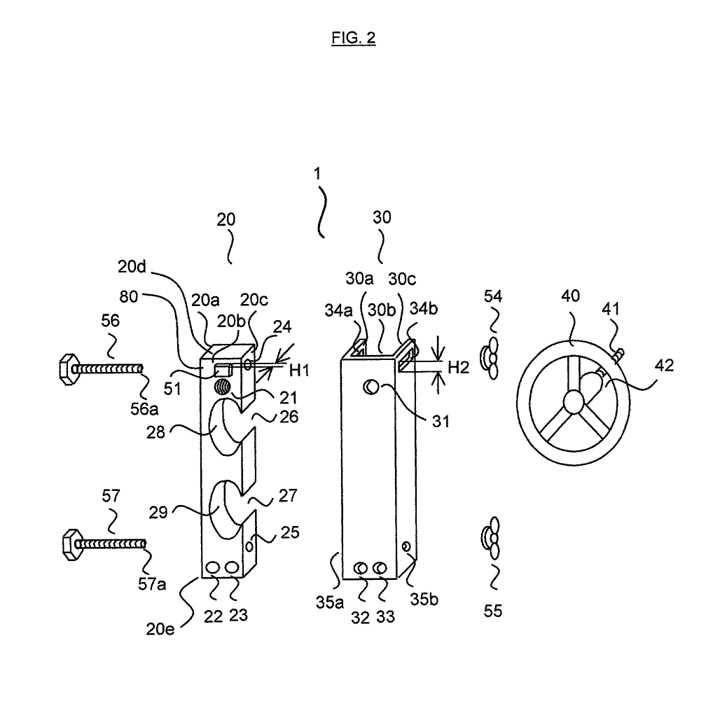

FIG. 1A shows a perspective view of an apparatus 1 and a rope 10. FIG. 1B shows a top view of the apparatus 1 and the rope 10 of FIG. 1A. FIG. 2 is a perspective view of the apparatus 1 of FIG. 1A taken apart. The apparatus 1 includes a base device 20, a cover device 30, and a handle device 40. The apparatus 1 further includes screws 56 and 57 and wing nuts 54 and 55 shown clearly in FIG. 2.

Referring to FIGS. 1A, 1B, and 2, the base device 20 includes portions 20a, 20b, and 20c, threaded friction adjustment hole 21, hook up holes 22 and 23, hole 24, hole 25, rope receiving openings 26 and 27, friction holes 28 and 29, minimum gap spacer 51, and upper part 80. The friction holes 28 and 29 may be different from each other in size and shape as long as the rope 10 can be placed into the friction holes 28 and 29.

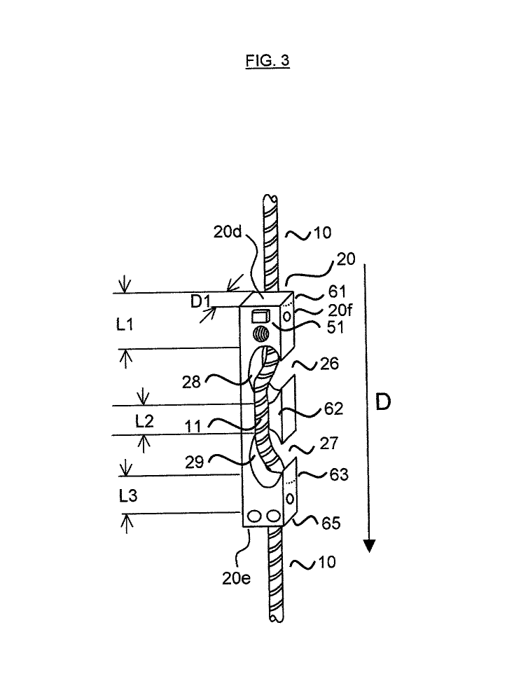

FIG. 3 shows a perspective view of the base device 20 and the rope 10 of FIG. 1A connected together without the cover device 30 or the handle device 40. The base device 20 also includes frictional surfaces 61, 62, 63, and bottom surface 65 shown in FIG. 3. The frictional surface 62 is located at the front portion 20b of the base device 20. The frictional surfaces 61 and 63 are located at the back portion 20f of the base device 20. The frictional surface 65 is located on the bottom 20e of the base device 20. The base device 20 is typically solid with the exception of the various holes and openings identified.

The cover device 30 includes side wall 30a, front wall 30b, and side wall 30c, friction adjustment hole 31, hook up holes 32 and 33, rectangular openings 34a and 34b, and holes 35a and 35b. The handle device 40 includes screw member 41 and disc member 42.

As shown in FIG. 3, portions of the rope 10 frictionally engage or contact back frictional surface 61, front frictional surface 62, and back frictional surface 63. The rope 10, as shown in FIG. 3, starts at the top 20d of the base device 20, goes along the back frictional surface 61, then goes through the friction hole 28, then goes along the front frictional surface 62, then goes through the friction hole 29, then goes along the back frictional surface 63, and finally runs away from the bottom or bottom surface 20e of the base device 20. In accordance with an embodiment of the present invention, the base device 20 can first be attached to the rope 10 as shown in FIG. 3. As shown by FIG. 3, there is no need to pass an open end of the rope 10 through the holes 26 and 27. The holes 26 and 27 are large enough to attach to the rope 10 at any portion of the rope 10.

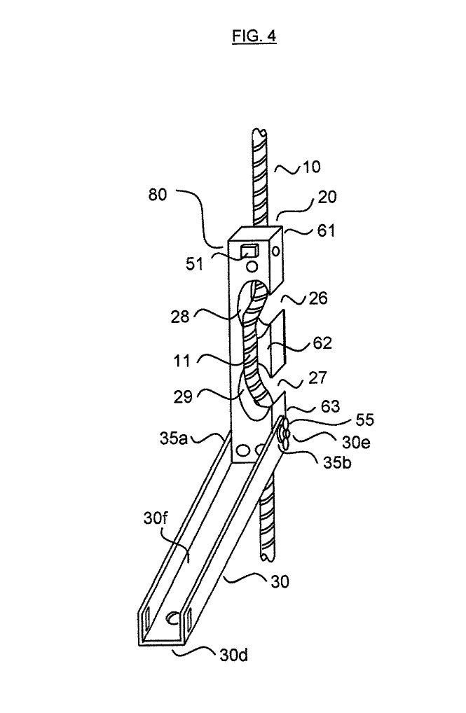

After the base device 10 has been attached to the rope 10 as shown in FIG. 3, a bottom end 30e of the cover device 30 can be attached to or near the bottom 20e or of the base device 20 as shown by FIGS. 2 and 4, by inserting the screw 57 into the opening 35a of the cover device 30, into and through the opening 25 of the base device 20, and then through the opening 35b of the cover device 30. The wing nut 55 can be screwed on at end 57a of the screw 57.

After the bottom end 30e of the cover device 30 has been connected to or near the bottom 20e of the base device 20, the cover device 30 can be rotated upwards into the position shown in FIG. 1A. The screw 56 shown in FIG. 2 can be inserted into the rectangular opening 34a of the cover device 30, then into and through the opening 24 near the top end or surface 20d of the base device 20, then into and through the rectangular opening 34b and finally the wing nut 54 can be threaded on and tightened at an end 56a of the screw 56.

After the cover device 30 has been attached at or near both ends or surfaces 30d and 30e to the base device 20 at or near ends or surfaces 20d and 20e, as shown in FIG. 1A, then the screw 41 of the handle device 40 can be screwed into the hole 21 of the base device 20, through the hole 31 of the cover device 30. When the screw 41 is tightened such as in a clockwise direction, the screw 41 will cause an inner surface 30f of the cover device 30 shown in FIG. 4, to press the rope 10 tightly against the frictional surface 62 of the base device 20. In this manner the base device 20 and the cover device 30 will be inhibited from sliding up and down the rope 10 to some extent, depending on how tightly the screw 41 is screwed in and on the size of the minimum gap spacer 51. The screw 41 can be progressively loosened, such as in a counter clockwise direction, to cause the inner surface 30f to more loosely press the rope 10 against the surface 62 or to not press the rope 10 against the surface 62 at all. The tightening or loosening of the screw 41 allows the base device 20 and the cover device 30 to slide down the rope 10 in the direction D shown in FIG. 1A, at different speeds (or not at all) depending on how the handle device 40 is turned.

Base device 20 provides a basic friction force between the base device 20 and the rope 10 that goes through the base device 20. The cover device 30 provides an additional friction force on the rope 10. The handle device 40 is a hand gripping handle which lets a user feel more secure, avoid hand burn, and adjusts the additional friction force, applied by cover device 30, through its inner surface area 30f shown in FIG. 4, by turning the handle device 40 and causing the disc member 42 together with the screw member 41 to move the cover device 30 towards or away from the base device 20. The diameter of the disc member 42 is typically greater than the hole 31 in cover device 30 so that the screw 41 passes through the hole 31 but the disc member 42 does not.

The friction force applied by the base device 20 without the cover device 30 can be called the basic friction force. The friction force applied by the cover device 30 depending on the setting of the handle device 40 can be called an additional adjustable friction force. The additional adjustable friction force counterbalances the weight of a descending person for ensuring a smooth descend with a controllable speed. For example, a user can turn the screw member 41 on the handle device 40 in such a way that the gap 60, shown in FIG. 1A, between the base device 20 and the cover device 30 is reduced or increased. Since a portion of the rope 10 goes through the gap 60 between the base device 20 and the cover device 30, particularly the portion that goes over surface 62 of base device 20 shown in FIG. 3, a reduced gap 60 leads to increased friction force while an increased gap 60 decreases the friction. By adjusting the gap 60 using the handle device 40, a user can easily fine-tune the additional adjustable friction force needed to counterbalance his/her own weight and hence adjust the descending speed along the rope 10.

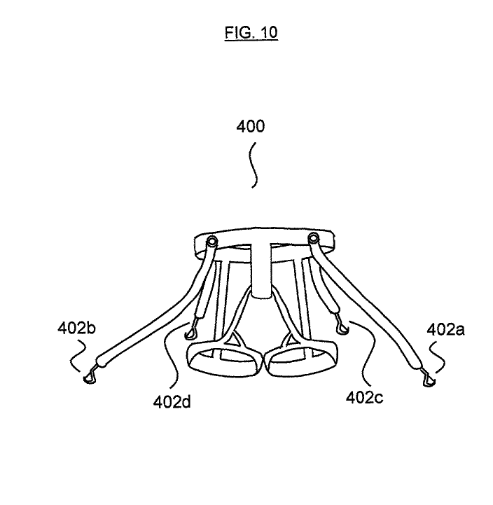

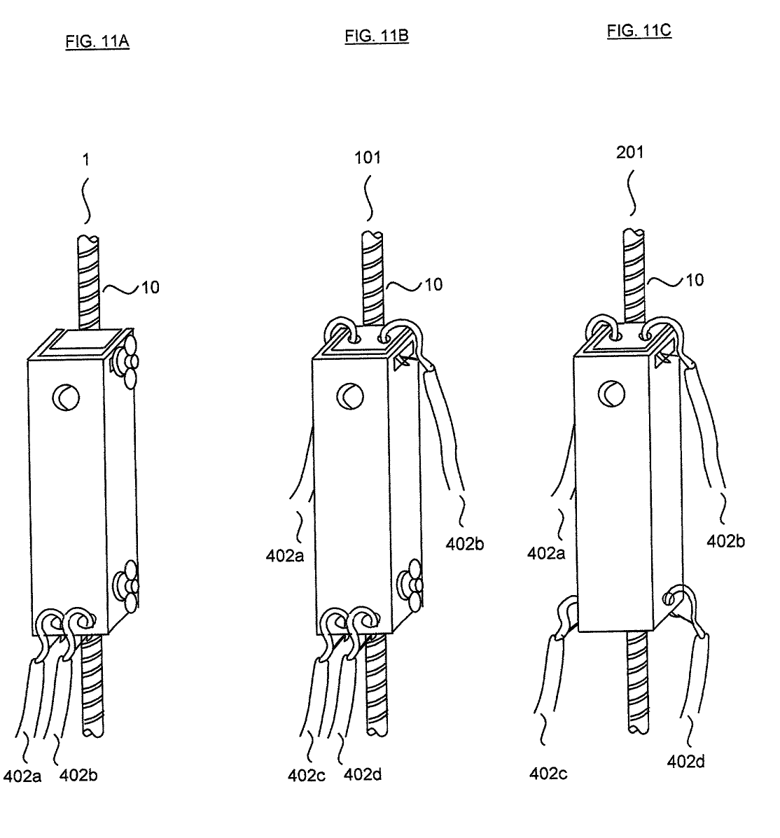

The apparatus 1 provides a plurality of hook-up holes, such as hook-up holes 32 and 33 on the cover device 30, so that a user of the apparatus 1 can easily hook up his/her harness, such as a harness 400 shown in FIG. 10, to those holes.

The base device 20 may be bar shaped and solid with the exception of the various openings and holes. The cover device 30 may be U-shaped, with the walls 30a, 30b, and 30c defining the U shape. The minimum gap spacer 51 may ensure a minimum gap, between the surface 62 of the base device 20 and the inner surface 30f of the cover device 30 for not allowing an infinite or high compression of the rope 10 which could potentially lead to a full stop of the apparatus 1 along the rope 10. (Note: The full stop may be very undesirable if many people need to descend by a single rope. The minimum gap spacer 51 has a certain height H1, shown in FIG. 2, which is smaller than the diameter of the rope 10. The handle device 40 can be used to decrease the gap 60 between the base device 20 and the cover device 30 so that the rope 10 passing through the gap 60 can be compressed for creating stronger friction force. However, the minimum gap spacer 51 may be used to ensure that the minimum gap for gap 60 between the base device 20 and the cover device 30 is maintained independent of the rotation of the handle device 40 (after the inner surface 30f of the cover device 30 touches the top of the minimum gap spacer 51 and the minimum gap spacer 51 is in general is rigid, and hard, and not elastic, unlike the rope 10, the cover device 30 will not be able to get closer to the base device 20 and the handle device 40 may not be further turned clockwise for example). By selecting a suitable height H1 of the minimum gap spacer 51, the cover device 30 can only compress the rope 10 to a certain degree determined by the height H1 in at least one embodiment. This ensures that the additional friction force has a designed maximum. As long as this maximum additional friction force is designed to be below a certain threshold, a full stop may be avoided, at least in some embodiments.

The threaded friction adjustment hole 21 receives the screw member 41 on the handle device 40. The hook-up holes 22 and 23 on the base device 20, let a user's harness, such as harness 400 of FIG. 10, be hooked up to the base device 20. The friction holes 28 and 29 provide the basic friction force between the base device 20 and the rope 10 as shown in FIG. 1. The rope receiving openings 26 and 27 of the friction holes 28 and 29, respectively, allow the rope 10 to easily get into the friction holes 28 and 29. The holes 24 and 25 are used together with screws 56 and 57 and wing nuts 54 and 55 for holding the base device 20 and the cover device 30 together. There are many other commonly available possibilities to hold the base device 20 and the cover device 30 together besides a screw with a wing nut, which would be known by those skilled in the art.

The cover device 30 is designed to be slightly larger than the base device 20 so that the base device 20 can be covered on three sides by the cover device 30. The base device 20 is designed to lie within the walls 30a, 30b, and 30c of the cover device 30, so that portions 20a, 20b, and 20c of the base device face and lie adjacent to walls 30a, 30b, and 30c of the cover device 30, respectively.

The friction adjustment hole 31 may be non-threaded and may have a diameter larger than the diameter of the screw member 41 but smaller than the diameter of the disc member 42. The rectangular openings 34a and 34b may have a height H2, shown in FIG. 2, which may be slightly larger than the diameter of the screw 56. The rectangular openings 34a and 34b may have a length L4 that may be smaller than Dl and much larger than the diameter of the screw 56, which allows for adjustment of the adjustable friction force. The screw 56, the rectangular openings 34a and 34b, and the wing nut 54 are used for holding the base device 20 and the cover device 30 together loosely. The reason for using the rectangular openings 34a and 34b instead of a regular hole is to allow the gap 60 between the base device 20 and the cover device 30 to be adjusted using the handle device 40.

The rope receiving openings 26 and 27 of the friction holes 28 and 29, respectively, have a larger dimension than the diameter of the rope 10. This enables the rope 10 to be placed into the friction holes 28 and 29 through the corresponding rope receiving openings 26 and 27 as shown in FIG. 3. The two friction holes 28 and 29 should have sufficiently rounded and smoothed edge areas, especially those edge areas where the rope 10 passes through. This is important for not damaging the rope 10 during the descending process.

The three frictional contact surfaces 61, 62, and 63 provide a basic friction force to roughly counterbalance the weight of a person who will be descending along the rope 10. The lengths L1, L2, and L3, shown in FIG. 3 of these three friction contact surfaces 61, 62, and 63, respectively, as well as their surface textures and finishes determine the basic friction force between the base device 20 and the rope 10. In general, the larger the friction contact surfaces 61, 62, and 63 and the rougher the surface textures and the finishes are, the larger the basic friction force between the base device 20 and the rope 10. By increasing the length, such as L1, L2, or L3, and hence the area of the three friction contact surfaces 61, 62, and 63 between the base device 20 and the rope 10, the basic friction force can be increased.

In addition, the depth, D1, of the base device 20, shown in FIG. 3, also contributes to the total friction force between the base device 20 and the rope 10. The larger the depth, D1, of the base device 20, the more twist of the rope 10 it causes, and consequently the larger the basic friction force. Therefore, the present invention in at least some embodiments, provides great and flexible possibilities by varying the lengths L1, L2, and/or L3 of the three friction contact surfaces 61, 62, and 63, their surface textures and the finishes, as well as the depth, D1, of the base device 20 to customize the apparatus 1 for people in many dispersed weight ranges. For example, many weight-customized devices or apparatus can be provided for different weight ranges, such as less than 50 pounds, 50-100 pounds, 100-150 pounds, 150-200 pounds, 200-250 pounds, 250-300 pounds, and over 300 pounds. These weight ranges are only selected as an example for illustrating the common weight ranges. Certainly, they may be set otherwise. This weight-customized capability of the present invention, and in particular of apparatus 1, offers a great advantage over most descending devices that are not weight-customizable because the user of the apparatus 1 does not have to adjust the friction force for controlling the descending speed in a great range from say 50 to 300 pounds, for example, when descending along a rope. This can be an important advantage over other devices because many users may be panicked during the descending process and hence may not be able to adjust much of the apparatus 1 during the relatively short period of time for descending.

In operation, the apparatus 1 as shown in FIGS. 1-4 functions as follows. The base device 20 and the cover device 30 are usually held together by the screw 57 and the nut 55 through the holes 25 and 35a and 35b, as shown by FIGS. 1 and 2. The nut 55 is only loosely tightened so that the cover device 30 can still be rotated towards or away from the base device 20 along the screw 57 as the rotation axis, as shown in FIG. 4. After the cover device 30 is in an “uncovered” state (rotated for example roughly ninety degrees with respect to the base device 20 as shown in FIG. 4), the base device 20 is exposed in such a way that the rope 10 can easily be placed into the two friction holes 28 and 29 through the corresponding rope receiving openings 26 and 27, respectively, as shown in FIG. 4. After the rope 10 is placed into the friction holes 28 and 29, the cover device 30 can be rotated back to cover the base device 20 and the rope 10 to the state as shown in FIG. 1A. The cover device 30 is designed to be only slightly wider than the base device 20 so that the rope 10 will not be able to “escape” from the friction holes 28 and 29 or through the rope receiving openings 26 and 27, respectively.

The screw 56 and the nut 54 are then used to loosely hold the upper end of the base device 20 and the cover device 30 together through the hole 24 and the rectangular openings 34a and 34b. Again, the screw 56 and the nut 54 are only loosely tightened so that the gap 60 between the base device 20 and the cover device 30 can still be adjusted. After the screw 56 and the nut 54 are loosely tightened, the screw member 41 on the handle device 40 is screwed into the threaded friction adjustment hole 21 and the non-threaded friction adjustment hole 31 (so that the screw member 41 can easily pass through the non-threaded friction adjustment hole 31) as shown by FIGS. 1A, 1B, and FIG. 2. By turning the handle device 40, the disc member 42 as shown in FIGS. 1A, 1B, and 2 with a larger diameter than the diameter of the adjustment holes 31 and 21, shown in FIG. 2, moves the cover device 30 towards or away from the base device 20 to decrease or increase the gap 60, as shown in FIG. 1, between the base device 20 and the cover device 30, respectively. Since a portion 11 of the rope 10 as shown in FIG. 3 passes through the gap 60 between the base device 20 and the cover device 30, the decreased gap 60 leads to a stronger additional friction force and the increased gap 60 to a weaker one. Therefore, a user can easily use the handle device 40 to fine-tune the additional friction force needed to control the descending speed along the rope 10. The minimum gap, hence the maximum additional friction force, is ensured by the depth of H1 of the minimum gap spacer 51, shown in FIG. 2.

Modifications can be made to the apparatus 1 of FIGS. 1-4 to further simplify the structure. For example, the screw 56, the nut 54, the hole 24 and the rectangular openings 34a and 34b as shown in FIGS. 1-2 may all be omitted. In fact, the handle device's screw 41 already holds the upper part 80 of the base device 20 and the cover device 30 together anyway. The screw 56, the nut 54, the hole 24 and the rectangular openings 34a and 34b for holding the upper part 80 of the base device 20 and the cover device 30 together may be redundant and therefore optional. By omitting these components, we can further reduce the time needed for hooking up and releasing the apparatus 1 on the rope 10. In operation, a user does not need to tighten the screw 56 and the nut 54 anymore after the placement of the rope 10 into the base device 20. The user will directly screw the screw member 41 of the handle device 40 through the adjustment hole 31 on the cover device 30 into the threaded adjustment hole 21 on the base device 20 for holding the upper part 80 of the base device 20 and the cover device 30 together.

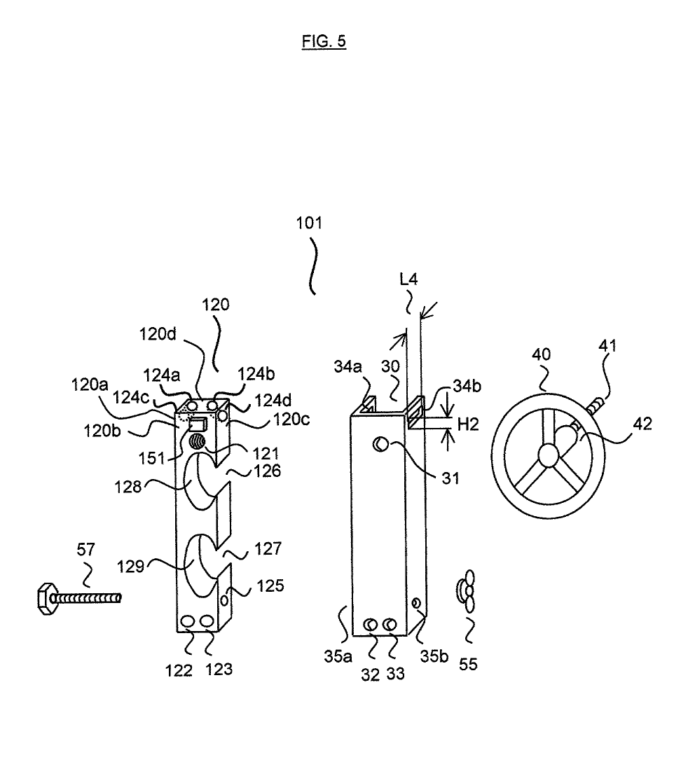

Although the previous configuration will generally work, it may not provide the best configuration for safety if the user has accidentally completely unscrewed the handle device 40 from the adjustment hole 21 on the base device 20. This could cause the upper part of the base device 20 and the cover device 30 to come apart. In order to avoid this potential danger from happening, a new modification can be added as shown in FIG. 5.

FIG. 5 is a perspective view of an apparatus 101 in accordance with another embodiment of the present invention, with the apparatus 101 shown taken apart. The apparatus 101 includes a base device 120, the cover device 30, and the handle device 40. Cover device 30 and handle device 40 are the same as for the embodiment of FIGS. 1-4. The base device 120 is the same as the base device 20 of FIGS. 1-4 except that the base device 120 includes a first opening which starts with a hole 124b on the top 120d of the base device 120 ends with a hole 124d on the upper right side 120c of the base device 120, and a second opening which starts with a hole 124a on the top 120d of the base device 120 and ends with a hole 124c on the upper left side 120a. The base device 120 includes components 121, 122, 123, 126,127, 128, 129 and 151 which are, except for the exceptions previously described, the same as similarly numbered components 21, 22, 23, 26, 27, 28, 29 and 51 of apparatus 1 of FIGS. 1-4.

Hooks, of a harness, such as harness 400 of FIG. 10, can be attached into the first and second openings of apparatus 101. For example, hook 402a in FIG. 10 can be inserted into the hole 124a and then would come out opening 124c, and then out of rectangular opening 34a of the cover device 30, assuming the base device 120 is within the cover device 30 similar to FIG. 1A. Hook 402b can be inserted into hole 124b and come out hole 124d, and then out of rectangular opening 34b, again assuming the base device 120 is within the cover device 30 similar to FIG. 1A. In this manner hooks 402a and 402b can be hooked to or attached to the base device 20 and also can connect the base device 20 to the cover device 30.

If the safety harness has only two hooks, then the user should hook them up with these new hook-up holes 124a-124d together with the rectangular openings 34a and 34b on the cover device 30 for holding the base device 120 and the cover device 30 together. If the safety harness has four hooks, then these new hook-up holes 124a-124d and the original hook-up holes 122 and 123 located at the bottom of the base device 120 and the hook-up holes 32 and 33 located at the bottom of the cover device 30 may also be used. Hook 402c of harness 400 can be inserted into and through hole 32 and then into and through hole 122. Hook 402d of harness 400 can be inserted into and through hole 33 and then into and through hole 123.

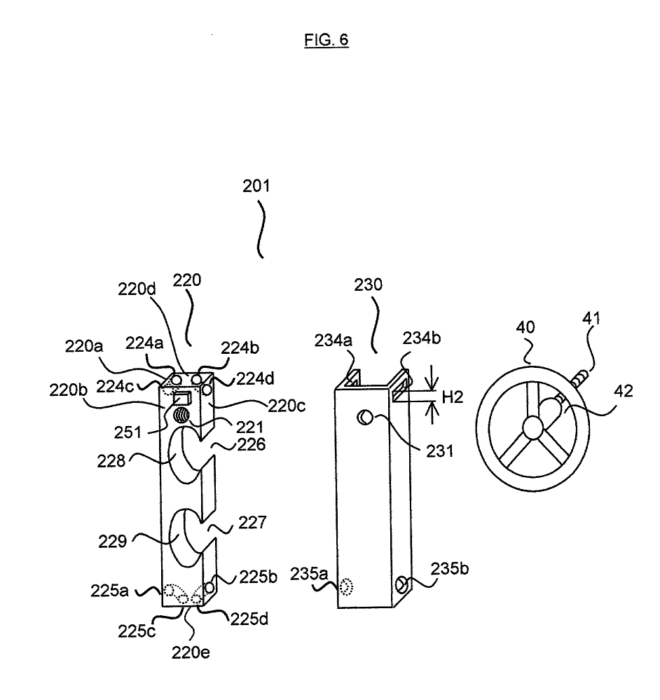

FIG. 6 is a perspective view of an apparatus 201 in accordance with another embodiment of the present invention with the apparatus 201 taken apart. Apparatus 201 includes a base device 220, a cover device 230, and the handle device 40. The handle device 40 is the same as in the embodiments of FIGS. 1-5.

The base device 220 is the same as the cover device 120 of FIG. 5, with a few exceptions. Firstly, the base device 220 includes an opening which starts at a hole 225d on the bottom 220e of the base device 220 and ends at the hole 225b on the right side of the base device 220 and the base device 220 also includes an opening which starts at a hole 225c on the bottom 220e and ends at the hole 225a on the left side of the base device 220, while the base device 120 does not include such openings. Also the base device 120 includes openings 122, 123, and 125 while the base device 220 does not include similar openings. Components 220a-e, 221, 224a-d, 226-229, 251 are, except for the exceptions similarly described, the same as similarly numbered components 120a-e, 121, 124a-d, 126-129, and 151.

The cover device 230 is the same as the cover device 30 of FIG. 5 with a few exceptions. The cover device 230 includes an opening which runs from a hole 235a on the left side to a hole 235b on the right side of cover device 230. The cover device 30 does not include such an opening and instead has openings 32, 33, and 35 shown in FIG. 5. The cover device 230 includes opening 231, and rectangular openings 234a and 234b which are the same as openings 31, 34a, and 34b of FIGS. 1A-B.

The retaining screw 57 and the wing nut 55 are used with the embodiment of FIG. 5. However the embodiment of FIG. 6 does not require the screw 57 or the wing nut 55.

In the operation of the apparatus 201 of FIG. 6, a user can insert hook 402a into hole 224a and out hole 224c, and then out hole 234a, insert hook 402b into hole 224b out hole 224d and out hole 234b, insert hook 402c into hole 235a, then into hole 225a and out hole 225c, and insert hook 402d into hole 235b, then into hole 225b and then out hole 225d. In the example of FIG. 6, the four hooks 402a-d from the safety harness 400 hold the base device 220 and the cover device 230 together instead of the screws 56 and 57, and the nuts 54 and 55. The FIG. 6 embodiment can not only further reduce the total number of required components to three but also further decreases the overall hook-up time of the apparatus 201 (versus the apparatus 1 of FIG. 1A) on the rope 10 by eliminating the need of using the screw 57 and the nut 55. Although the bottom hook-up holes 32 and 33 on the cover device 30 and holes 122 and 123 on the base device 120 as shown in FIG. 5 are placed in the front panel or front side 20b or 120b of the apparatus 1 or 101, the holes 32, 33, 22, and 23 may also be placed on the left and the right side panel of either the base device 20 or the cover device 30 just like the hook-up holes in 124a-d in the upper part of the base device 120 as shown in FIG. 5.

Although apparatus 1, apparatus 101, and apparatus 201 have been shown and described only with two main friction holes 28 and 29 (or 128 and 129, or 228 and 229) on the base device 20 (or base device 120 and 220 respectively), it is a natural extension and easily envisioned to include more than two friction holes on the apparatus 1, 101, 201. In general, more friction holes lead to stronger friction force between the rope 10 and apparatus 1, 101, or 201. Such natural extensions are hereby included within one or more embodiments of the present invention.

Apparatus 1, apparatus 101, or apparatus 201 have the minimum gap spacer 51, 151, or 251 for preventing a total stop. However, if the apparatus is intended only for personal mountain climbing or as a personal descending device where only one or a few people need to descend from a rope instead of lots of people, a full stop may not be a bad function. Therefore, in this particular situation, the minimum gap spacer 51 may be omitted from apparatus 1, apparatus 101, and apparatus 201 for allowing a full stop of the device on a rope.

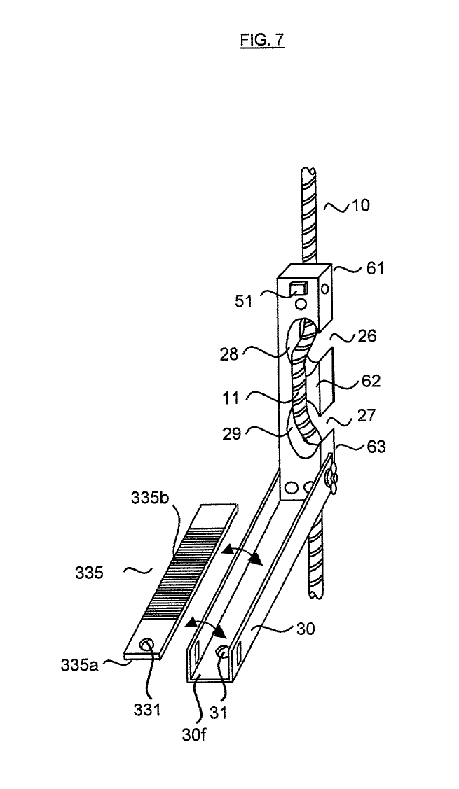

FIG. 7 shows the perspective view of FIG. 4 and a removable plate 335 for insertion into the cover device 30 of FIG. 4. The removable friction plate 335 can be placed on the inside of the cover device 30 as shown by FIG. 7, so that the total friction of the apparatus 1 (or similarly of the apparatus 101 or 201) with the rope 10 can be pre-adjusted by using different removable friction plates with different surface textures, on surface 335b, and finishes at least in those areas where the rope 10 comes into contact with the removable friction plate 335. The removable friction plate 335 has also a friction adjustment hole 331. The removable friction plate 335 may be added to the cover device 30, as illustrated, with its friction adjustment hole 331 aligned with the friction adjustment hole 31 on the cover device 30, and its rear side 335a contacting the inside surface 30f of the cover device 30. The removable friction plate 335 may be attached to the cover device 30 by using some weak removable adhesives, Velcro (trademarked) belt, or other means.

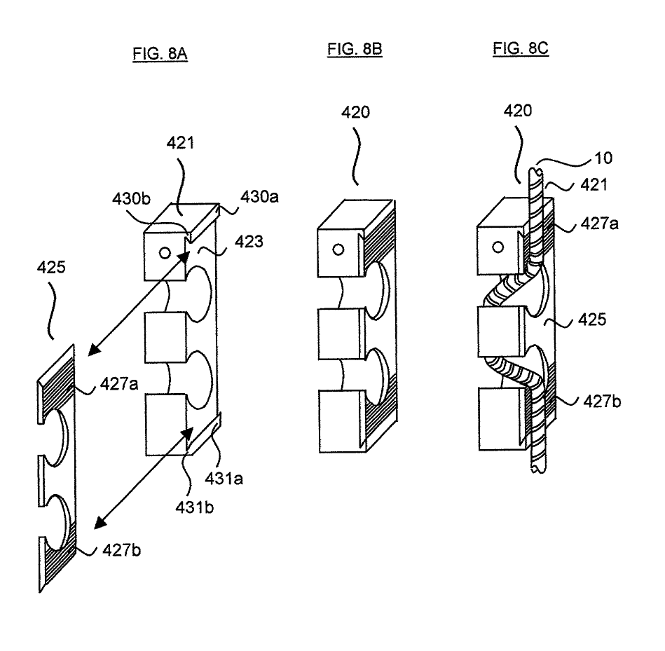

The embodiments contemplated by the present invention may further be extended by adding one or two removable friction plates to be placed on the front and/or back side of the base device 20 (or base device 120 or 220). FIGS. 8A, 8B, and 8C show perspective views of another base device 421 and another plate 425 in accordance with another embodiment of the present invention. FIG. 8A shows the plate 425 before being inserted into the base device 420. The base device 421 may be similar to base device 20 except that base device 421 may include rails 430a and 431a forming channels 430b and 431b. The plate 425 may be inserted inside the channels 430b and 431b as shown by FIGS. 8A and 8B. The rope 10 may be inserted into the new base device 420 which is base device 421 combined with the plate 425 as shown in FIG. 8C.

As shown in FIGS. 8A-C, the removable plate 425 may slide in to the back side 423 of base device 421 to form a new base device 420 that can be used similarly as the base device 20 in apparatus 1 (or base device 120 or base device 220). By using various removable friction plates with different surface textures and finishes in areas 427a and 427b, the total friction of the apparatus 1, 101, and 201 with the rope 10 may be pre-adjusted.

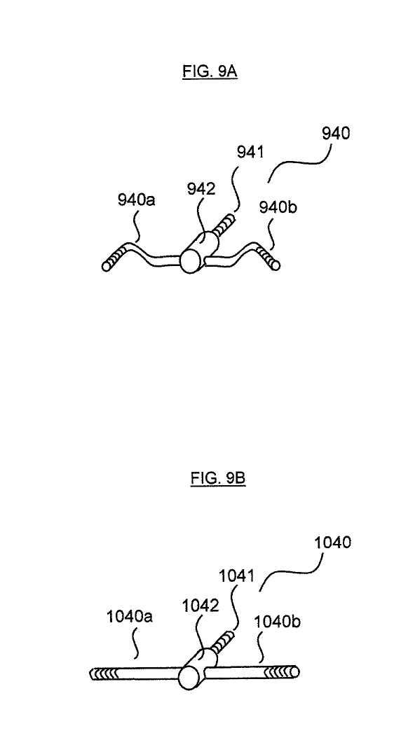

It also should be mentioned that the handle device may not necessarily always be wheel-shaped. A handle device 940 shown in FIG. 9A, having bicycle handles 940a and 940b, screw 941, and disc 942 can replace handle device 40. Also a handle device 1040, shown in FIG. 9B, having bicycle handles 1040a and 1040b, screw 1041, and disc 1042 can replace handle device 1040. The handles 940a and 940b and 1040a and 1040b may include gripping areas.

Although the illustrated embodiments may have two or four hook up holes for a safety harness, the implementation of the embodiments may include more hook up holes as needed. It is easily imaginable that more hook up holes may be added to the bottom part of the apparatus 1, 101, and 201 on the front, left and right sides of the apparatus, and to the upper part of the apparatus 1, 101, and 201 on the left and right side of the apparatus if desirable.

For enhancing the feeling of security, it may also be beneficial to use a personal safety net large enough to enclose a human in addition to a safety harness. The personal safety net may also have hooks that can easily be hooked up with the apparatus 1, 101, or 201, shown in FIGS. 1, 2, 5, and 6.

I claim:

1. An apparatus comprising
a base device;
a cover device;
wherein the base device can be connected to a rope so that the base device can slide up and down the rope with the base device engaging the rope with a basic friction force;
and wherein the cover device can be connected to the base device, and a position of the cover device with respect to the base device can be adjusted so that an adjustable friction force can be applied by the cover device and the base device to the rope.

2. The apparatus of claim 1 further comprising
a handle device which can adjust the position of the cover device with respect to the base device to adjust the adjustable friction force applied to the rope.

3. The apparatus of claim 1 wherein
the handle device can be connected to the base device.

4. The apparatus of claim 3 wherein
the handle device when connected to the base device can be rotated in a first direction to cause the cover device to move closer to the base device and in a second direction to cause the cover device to move farther away from the base device.

5. The apparatus of claim 1 wherein
the base device includes a plurality of holes, and a hook of a harness can be attached to each of the plurality of holes.

6. The apparatus of claim 1 wherein
the cover device includes first and second rectangular openings,
and wherein a position of a screw within the first and second rectangular openings can be adjusted to adjust the adjustable friction force.

7. The apparatus of claim 1 further comprising
a plate which can be inserted into the cover device.

8. The apparatus of claim 7 wherein
the cover device is U-shaped having left, right, and front sides, and the plate can be inserted into the cover device so that it lies on the front side of the cover device;
and wherein when the position of the cover device with respect to the base device is adjusted, an amount of friction applied by the plate to the rope is adjusted.

9. The apparatus of claim 1 wherein
the base device is comprised of
first and second friction holes; and
wherein the first and second friction holes each have openings which are larger than a diameter of the rope.

10. The apparatus of claim 9 further wherein
the base device is comprised of
at least one further friction hole.

11. The apparatus of claim 1 further wherein
the base device is comprised of
a minimum gap spacer;
wherein the minimum gap spacer defines the smallest gap between the base device and the cover device so that the rope passing through the smallest gap may slide through the smallest gap.

12. The apparatus of claim 3 further wherein
the base device is comprised of
a threaded friction adjustment hole to which the handle device can be connected, which can be used for adjusting the adjustable friction force by turning the handle device.

13. The apparatus of claim 1 further wherein
the base device is comprised of
a first removable surface plate.

14. The apparatus of claim 13 further wherein
the first removable surface plate has a particular surface texture which generates a particular range of friction forces between the rope and the first removable surface plate.

15. The apparatus of claim 14 further comprising
a second removable surface plate which has a particular surface texture which is different from the first removable surface plate and which generates a particular range of friction forces between the rope and the first removable surface plate.

16. The apparatus of claim 12 wherein
the handle device is comprised of
a handle member;
a screw member;
a disc member;
wherein the handle member provides a handle for gripping with both hands and for adjusting the adjustable friction force by turning the handle member;
wherein the screw member can be screwed into the threaded friction adjustment hole on the base device through a friction adjustment hole on the cover device;
wherein the friction adjustment hole on the cover device has a slightly larger diameter than a diameter of the screw member; and
wherein the disc member has a larger diameter than a diameter of the friction adjustment hole on the cover device.

17. The apparatus of claim 16 wherein
the handle member is shaped like a wheel.

18. The apparatus of claim 16 wherein
the handle member is shaped like a elongated rod with two hand gripping areas.

19. The apparatus of claim 18 further wherein
the handle member is shaped like a steering handle of a bike.
